(19) United States
(12) Patent Application Publication
(10) Pub. No.: US 2015/0243238 A1
(43) Pub. Date: Aug. 27, 2015

(54) DISPLAY DEVICE

(71) Applicant: Samsung Display Co., Ltd., Yongin-City (KR)

(72) Inventors: Mee-Hye JUNG, Yongin-City (KR); Jun-Ki JEONG, Yongin-City (KR); IL-Gon KIM, Yongin-City (KR); Sang-Jin JEON, Yongin-City (KR); Kee-Bum PARK, Yongin-City, (KR)

(21) Appl. No.: 14/566,466

(22) Filed: Dec. 10, 2014

(30) Foreign Application Priority Data
Feb. 25, 2014 (KR) 10-2014-0021785

(51) Int. Cl. G09G 3/36

(52) U.S. Cl. CPC G09G 3/3677; G09G 3/3688

(57) ABSTRACT

There is provided a display device. The display device includes a display panel divided into a display region and a non-display region, with the display region having data lines, scan lines, and pixels connected to the data lines and the scan lines. The display device include a data driver to output data voltage to the data lines, and a scan driver to sequentially output scan signals to the scan lines. The display region is divided into a first region and a second region. A first portion of the scan driver is formed in the non-display region, while a second portion of the scan driver is formed in the first region. A pixel of the pixels formed in the first region comprises a single pixel electrode, and a pixel of the pixels formed in the second region comprises a plurality of pixel electrodes.

### CROSS-REFERENCE TO RELATED APPLICATION

This application claims priority to and the benefit of Korean Patent Application No. 10-2014-0021785, filed on Feb. 25, 2014, in the Korean Intellectual Property Office, the entire contents of which are incorporated herein by reference in their entirety.

### BACKGROUND

1. Field of the Invention

The present invention relates to a display device.

2. Description of the Related Art

There has been an increasing demand for a display device for displaying an image with the growth of an information-oriented society. Recently, there have been developed and available various types of flat panel displays (FPDs) capable of reducing the weight and volume of a cathode ray tube, which are disadvantages. For example, several flat panel displays such as liquid crystal displays (LCDs), plasma display panels (PDPs), or organic light emitting diodes (OLEDs) are utilized.

The display device includes a display panel including pixels arranged in a matrix form in a region that is defined by the intersecting structure of scan lines and data lines, a scan driver configured to supply scan signals to the scan lines, and a data driver configured to supply data voltage to the data lines. The scan driver may be implemented by a tape automated bonding (TAB) method wherein a printed circuit board on which a gate drive integrated circuit is mounted is attached to the display panel, or by a gate driver in panel (GIP) method wherein the gate driver is directly formed in a non-display region of the display panel.

When comparing the GIP method with the TAB method, the GIP method is advantageous in that a process of attaching the printed circuit board to the display panel is not required, so that the slimness of the display device is realized, thus affording good external appearance. Further, when comparing the GIP method with the TAB method, the GIP method is advantageous in that the gate drive integrated circuit and the pixels can be simultaneously formed on the display panel, so that a reduction in cost is achieved. Moreover, when comparing the GIP method with the TAB method, the GIP method is advantageous in that the scan signals can be directly designed by a display panel maker.

Meanwhile, in recent years, the external appearance of the display device becomes more important. In order to give good external appearance to the display device, a bezel region of the display device is minimized. The bezel region is an edge region surrounding the display device, and includes a non-display region where an image is not displayed. The GIP method is problematic in that a size of the gate drive integrated circuit should be decreased to reduce the non-display region of the display panel.

### SUMMARY OF INVENTION

An aspect of the invention provides a display device, which is capable of reducing a bezel by minimizing a scan driver formed in a non-display region of a display panel.

The invention provides a display device including a display panel divided into a display region and a non-display region, with the display region having data lines, scan lines, and pixels connected to the data lines and the scan lines. The display region includes a first region and a second region. The display device further includes a data driver configured to output data voltage to the data lines; and a scan driver configured to sequentially output scan signals to the scan lines A first portion of the scan driver is formed in the non-display region, while a second portion of the scan driver is formed in the first region. A pixel of the first region comprises a single pixel electrode, and a pixel of the second region comprises a plurality of pixel electrodes.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a perspective view showing an example of a display device;

FIG. 2 is a sectional view taken along the line I-I′ of FIG. 1;

FIG. 3 is a block diagram showing a display device according to an embodiment of the present invention;

FIG. 4 is an equivalent circuit diagram showing an example of pixels in a first region connected to a j-th scan line and a j-th stage of FIG. 3;

FIG. 5 is an equivalent circuit diagram showing an example of pixels in a second region connected to the j-th scan line of FIG. 3;

FIG. 6 is a plan view showing an example of the pixels in the first region of FIG. 4;

FIG. 7 is a cross-sectional view taken along the line II-II′ of FIG. 6;

FIG. 8 is a cross-sectional view taken along the line III-III′ of FIG. 6;

FIG. 9 is a plan view showing an example of the pixels in the second region of FIG. 5; and

FIG. 10 is a plan view showing another example of the pixels in the second region of FIG. 5.

### DETAILED DESCRIPTION

The invention will be described more fully hereinafter with reference to the accompanying drawings, in which example embodiments of the inventions are shown. This invention may, however, be embodied in many different forms and should not be construed as limited to the embodiments set forth herein. Like reference numerals designate like elements throughout the specification. In the following description, if it is decided that the detailed description of known function or configuration related to the invention makes the subject matter of the invention unclear, the detailed description is omitted.

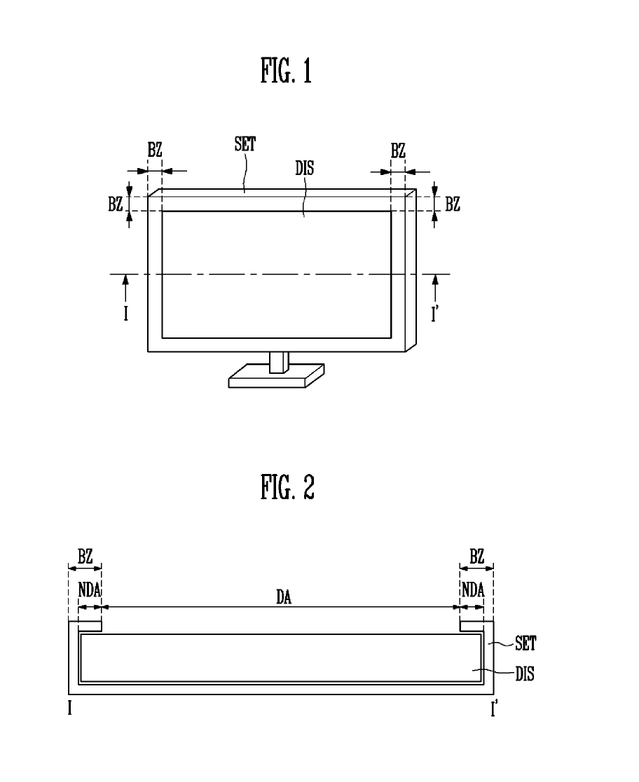

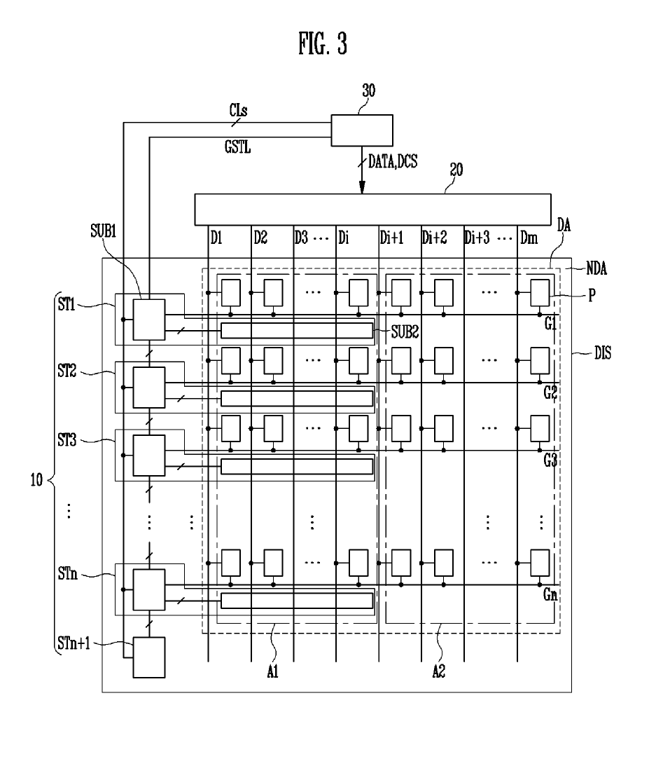

FIG. 1 is a perspective view showing an example of a display device. FIG. 2 is a sectional view taken along line I-I′ of FIG. 1. Referring to FIGS. 1 and 2, the display device includes a display panel DIS and a case SET that surrounds an edge of the display panel DIS. The display panel DIS may be implemented as a liquid crystal display (LCD), a field emission display (FED), a plasma display panel (PDP), or an organic light emitting diode (OLED). The display device may further include a backlight unit to emit light when the display panel DIS is implemented as the LCD.

The display panel DIS is divided into a display region DA where an image is displayed, and a non-display region NDA where no image is displayed. The display region DA corresponds to a pixel array region of the display panel DIS where pixels are arranged in a matrix (two-dimensional array) form, while the non-display region NDA corresponds to a region of the display panel DIS that is shielded by the case SET. It is to be noted that the non-display region NDA is usually formed in the edge region of the display panel DIS as shown in FIGS. 1 and 2, but may be formed in other regions without being limited to the edge region. The non-display region NDA may be provided between display regions DA. Further, a bezel region BZ is a region corresponding to the case SET that surrounds the edge of the display panel DIS as shown in FIGS. 1 and 2, this bezel region including the non-display region NDA of the display panel DIS.

Recently, the display device is manufactured by the gate driver in panel (GIP) method of directly forming the scan driver in the non-display region of the display panel rather than by the TAB method due to many advantages of the GIP method. In recent years, the bezel region BZ of the display device is minimized to improve the external appearance of the display device. In order to minimize the bezel region BZ of the display device, the non-display region NDA of the display panel DIS should be reduced. However, the GIP method is problematic in that it is difficult to be formed in the reduced non-display region of the display panel DIS.

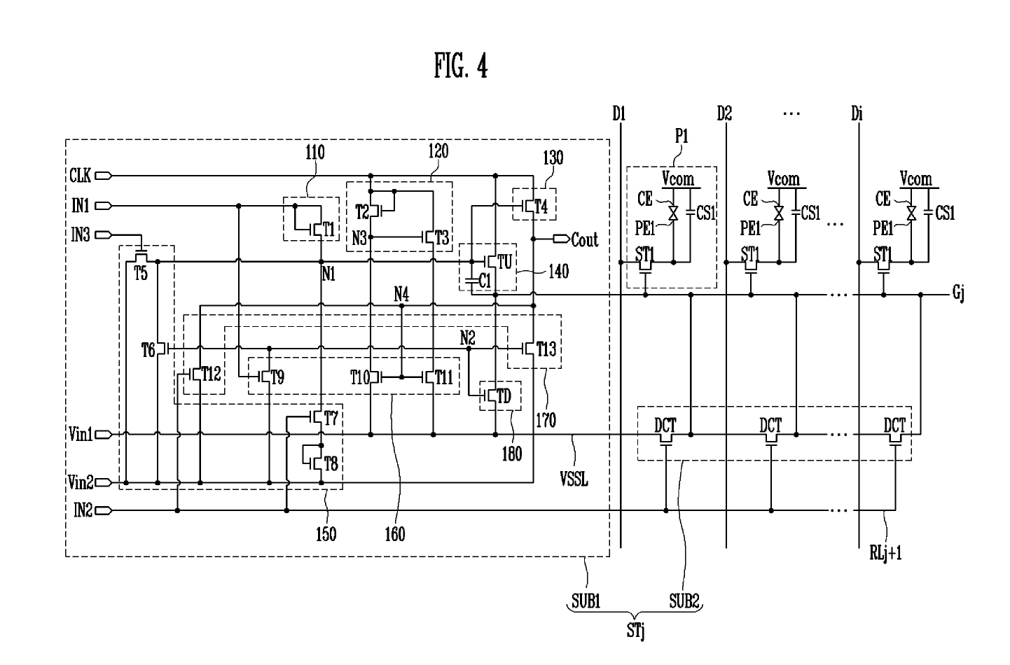

An embodiment of the present invention is implemented by an amorphous silicon gate (ASG) in pixel (AIP) method wherein a portion of the scan driver is formed in the display region DA of the display panel DIS. The ASG method is one of the GIP methods. Hence, the embodiment of the present invention may reduce the size of the scan driver formed in the non-display region NDA of the display panel DIS, thus allowing the size of the non-display region NDA of the display panel DIS to be reduced. Thus, the embodiment of the present invention may further reduce the bezel region of the display device. Hereinafter, the display device according to the embodiment of the present invention will be described in detail with reference to FIGS. 3 to 9.

FIG. 3 is a block diagram showing the display device according to the embodiment of the present invention. Referring to FIG. 3, the display device according to the embodiment of the present invention includes a display panel DIS, a scan driver 10, a data driver 20, and a timing controller 30. The display panel DIS according to the embodiment of the present invention may be implemented as the LCD, the FED, the PDP, or the OLED. Although it is described in the embodiment of the present invention that the display panel DIS is implemented as the LCD, it is to be noted that this invention is not limited thereto.

The display panel DIS is divided into the display region DA and the non-display region NDA. The display region DA is the region corresponding to a pixel array on which the pixels P are formed, with an image displayed on this region. The non-display region NDA is the region that is not the display region DA, with no image displayed on this region. In FIG. 3, the display region DA corresponds to the region defined inside dashed lines, while the non-display region NDA corresponds to the region defined outside the dashed lines.

Further, the display region DA is divided into a first region A1 where a portion of the scan driver 10 is formed, and a second region A2 where the scan driver 10 is not formed. For example, as shown in FIG. 3, the first region A1 may be the region including pixels that are connected to first to i-th (i is the natural number satisfying the following equation, 1≦i<m−1) data lines D1 to Di, and the second region A2 may be the region including pixels that are connected to i+1th to mth data lines Di+1 to Dm.

The data lines (D1 to Dm; m is the natural number of 2 or more) and the scan lines (G1 to Gn; n is the natural number of 2 or more) are formed on a lower substrate of the display panel DIS in such a way as to intersect with each other. The pixels P, arranged in the matrix form in a cell region defined by the data lines D1 to Dm and the scan lines G1 to Gn, are formed in the display region DA of the display panel DIS.

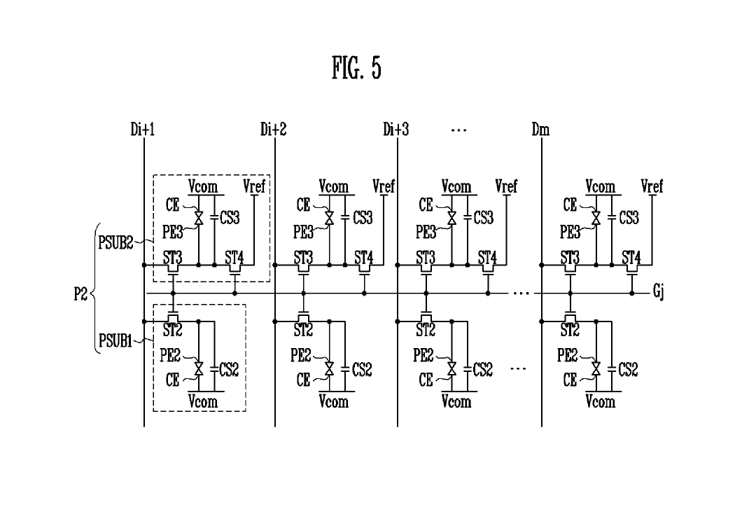

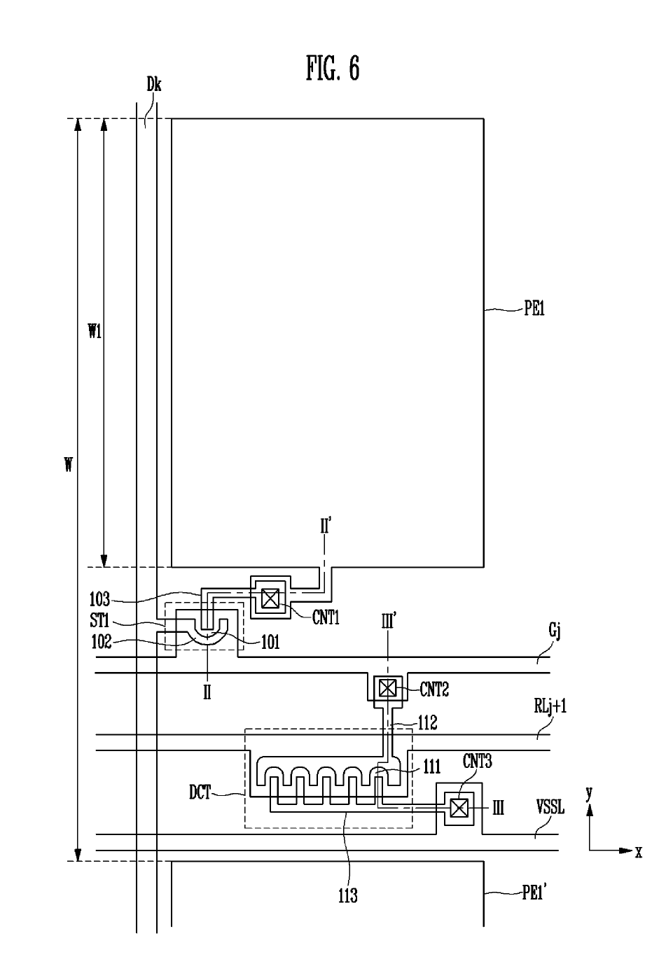

Pixels formed in the first region A1 of the display region DA are different from pixels formed in the second region A2. That is, the pixels formed in the first region A1 includes one pixel electrode, whereas the pixels formed in the second region A2 may include a plurality of pixel electrodes. The pixels formed in the first region A1 of the display region DA will be described in detail with reference to FIGS. 4 and 6. The pixels formed in the second region A2 of the display region DA will be described later in detail with reference to FIGS. 5, 8 and 9.

A shield member such as a black matrix, a color filter, and other components are formed on an upper substrate of the display panel DIS. An upper polarizing plate is attached to the upper substrate of the display panel DIS, and a lower polarizing plate is attached to the lower substrate. A light transmission axis of the upper polarizing plate and a light transmission axis of the lower polarizing plate may be formed to be perpendicular to each other. Further, an alignment film is formed on each of the upper and lower substrates to establish a pre-tilt angle of liquid crystal. A spacer is formed between the upper and lower substrates of the display panel DIS to maintain a gap of a liquid crystal layer. A common electrode is formed on the upper substrate in a vertical field driving method such as a twisted nematic (TN) mode and a vertical alignment (VA) mode, and is formed on the lower substrate in a horizontal field driving method such as an in plane switching (IPS) mode or a fringe field switching (FFS) mode. The liquid crystal mode of the display panel DIS may be implemented even as any liquid crystal mode including the above-mentioned TN mode, VA mode, IPS mode, and FFS mode.

The display panel DIS may be implemented as a transmissive LCD panel that modulates light from the backlight unit. The backlight unit includes a light source that is turned on depending on drive current supplied from a backlight-unit drive unit, a light guide plate (or diffusion plate), a plurality of optical sheets, etc. The backlight unit may be implemented as a direct type backlight unit or an edge type backlight unit. The light source of the backlight unit may comprise any one light source or two or more light sources selected from a group consisting of a hot cathode fluorescent lamp (HCFL), a cold cathode fluorescent lamp (CCFL), an external electrode fluorescent lamp (EEFL), a light emitting diode (LED), and an organic light emitting diode (OLED).

The scan driver 10 supplies the scan signals to the scan lines G1 to Gn of the display panel DIS under the control of the timing controller 30. The scan driver 10 may select pixels P to which data voltage is to be supplied, by sequentially supplying the scan signals to the scan lines G1 to Gn. A portion of the scan driver 10 is formed in the non-display region NDA of the display panel DIS, while a remaining portion of the scan driver 10 is formed in the first region A1 of the display region DA of the display panel DIS.

The scan driver 10 includes a shift register that sequentially generates output signals. As shown in FIG. 3, the shift register of the scan driver 10 may include a plurality of stages ST1 to STn a dummy stage STn+1 which are connected by a cascade joint. The first to n-th stages ST1 to STn sequentially output scan signals to the first to n-th scan lines G1 to Gn.

As shown in FIG. 3, each of the stages ST1, ST2, . . . , STn may include a first sub-stage SUB1 and a second sub-stage SUB2. The first sub-stage SUB1 is formed in the non-display region NDA of the display panel DIS, while the second sub-stage SUB2 is formed in the first region A1 of the display region DA of the display panel DIS. Here, the second sub-stage SUB2 may be disposed between the pixels P of the first region A1. For example, as shown in FIG. 3, the second sub-stage SUB2 may be disposed between the pixels connected to the j-th (j is the natural number satisfying the following equation, 1≦j≦n) scan line of the first region A1 and the pixels connected to the j−1th or j+1th scan line adjacent to the j-th scan line. A group of the first sub-stages of the stages can be referred to as a first portion of the scan driver 10, and a group of the second sub-stages of the stages can be referred to as a second portion of the scan driver 10.

The first sub-stage SUB1 receives, from the timing controller 30, a gate start signal GST or a carry signal of a front stage, clock signals, and a carry signal of a rear stage, and outputs the scan signal to the scan line. The second sub-stage SUB2 is electrically connected to the first sub-stage SUB1. The second sub-stage SUB2 may include at least one transistor or one active element such as a diode. For example, the second sub-stage SUB2 may discharge the scan line to gate off voltage using the transistor or the active element. The gate off voltage is the turn-off voltage of a switch transistor included in each pixel P. The first and second sub-stages SUB1 and SUB2 will be described in detail with reference to FIG. 4.

For the convenience of description, FIG. 3 shows that the scan driver 10 is formed in the non-display region NDA on one side of the display panel DIS, but this invention is not limited thereto. That is, the scan driver 10 may be formed in the non-display region NDA on both sides of the display panel DIS. In this case, odd-numbered stages ST1, ST3, . . . , STn−1 of the scan driver 10 may be formed in the non-display region NDA on one side of the display panel DIS, while even-numbered stages ST2, ST4, . . . , STn may be formed in the non-display region NDA on the other side of the display panel DIS.

The data driver 20 includes at least one source drive IC. The source drive IC converts digital image data (DATA), input from the timing controller 30, into positive/negative gamma correction voltage and thereby produces positive/negative analog data voltage. The positive/negative analog data voltage output from the source drive IC is supplied to the data lines D1 to Dm of the display panel DIS.

The timing controller 30 receives the digital image data (DATA) and the timing signals from a host system (not shown). The digital image data (DATA) is the digital data having a grayscale value. The timing signals may include a horizontal synchronization signal, a vertical synchronization signal, a data enable signal, a dot clock, etc.

The timing controller 30 generates a scan control signal for controlling the operation timing of the scan driver 10, and a data control signal DCS for controlling the operation timing of the data driver 20, based on the timing signals. The scan control signal includes a gate start signal, a clock signal, etc. The gate start signal is the signal that controls the output of the scan signal of the first stage ST1. As the gate start signal is input to the first stage ST1, the first to the n-th stages ST1 to STn of the scan driver 10 sequentially generate the output. The timing controller 30 outputs the gate start signal through a gate start signal line GSTL, and outputs the clock signals through clock lines CLs to the scan driver 10. The timing controller 40 outputs the digital image data (DATA) and the data-drive-unit control signal DCS to the data driver 20.

FIG. 4 is an equivalent circuit diagram showing an example of the pixels in the first region connected to the j-th scan line and the j-th stage of FIG. 3. In FIG. 4 are shown the first and second sub-stages SUB1 and SUB2 of the j-th stage STj that outputs the scan signal to the j-th scan line Gj, and the pixels P1 of the first region A1 connected to the j-th scan line Gj. As shown in FIG. 4, the pixels P1 of the first region A1 may be pixels connected to one of the first to the i-th data lines D1 to Di.

In the following description, the “front stage” designates a stage that is situated above a base stage. For instance, based on the j-th stage ST(j), the front stage denotes any one of the first to j−1th stages. The “rear stage” designates a stage that is situated under the base stage. For instance, based on the j-th stage ST(j), the rear stage denotes any one of the j+1th to the n-th stages.

First, the first sub-stage SUB1 of the j-th stage STj will be described in detail. A clock terminal CLK, first to third input terminals IN1, IN2 and IN3, first and second voltage input terminals Vin1 and Vin2, and a carry-signal output terminal Cout are formed on the first sub-stage SUB1.

The clock terminal CLK of the first sub-stage SUB1 is connected to any one of the plurality of clock lines CLs. For example, the clock terminal CLK of the first sub-stage SUB1 may be connected to either of the first and second clock lines. In this case, either of the first and second clock signals may be input into the clock terminal CLK of the first sub-stage SUB1. Each of the first and second clock signals may be a signal that periodically swings between the gate on voltage and the gate off voltage. Further, the second clock signal may be the signal that is opposite in phase to the first clock signal. In this regard, the first clock signal may be input into the odd-numbered stages, and the second clock signal may be input into the even-numbered stages.

The first input terminal IN1 of the first sub-stage SUB1 is connected to the gate start signal line GSTL or the carry-signal output terminal Cout of the front stage. In this case, the gate start signal or the carry signal of the front stage may be input into the first input terminal IN1 of the first sub-stage SUB1. For example, the start signal VST may be input into the first input terminal IN1 of the first sub-stage SUB1 of the first stage ST1, and the carry signal of the front stage may be input into the first input terminal IN1 of the first sub-stage SUB1 of the second to the n+1th stage ST2 to STn+1. In this context, the carry signal of the front stage may be the carry signal that is output from the carry-signal output terminal Cout of the j−1th stage STj−1.

The second input terminal IN2 of the first sub-stage SUB1 is connected to the carry-signal output terminal Cout of the rear stage. In this case, the carry signal of the rear stage may be input into the second input terminal IN2 of the first sub-stage SUB1. Here, the carry signal of the rear stage may be the carry signal that is output from the carry-signal output terminal Cout of the j+1th stage STj+1.

The third input terminal IN3 of the first sub-stage SUB1 is connected to the carry-signal output terminal Cout of another rear stage. In this case, the carry signal of the rear stage may be input into the third input terminal IN3 of the first sub-stage SUB1. Here, the carry signal of the rear stage may be the carry signal that is output from the carry-signal output terminal Cout of the j+2th stage STj+2.

A first voltage input terminal Vin1 of the first sub-stage SUB1 is connected to a first low-potential voltage supply line, and a second voltage input terminal Vin2 is connected to a second low-potential voltage supply line. In this case, first low-potential voltage VSS1 may be input into the first voltage input terminal Vin1 of the first sub-stage SUB1, and second low-potential voltage VSS2 may be input into the second voltage input terminal Vin2. The first low-potential voltage VSS1 may be different in level from the second low-potential voltage VSS2. The first and second low-potential voltage VSS1 and VSS2 may be previously determined through experiments.

The carry-signal output terminal Cout of the first sub-stage SUB1 is connected to the second input terminal IN2 of the front stage, the third input terminal IN3 of another front stage, and the first input terminal IN1 of the rear stage. For example, the carry-signal output terminal Cout of the first sub-stage SUB1 of the j-th stage STj may be connected to the second input terminal IN2 of the j−1th stage, the third input terminal IN3 of the j−2th stage, and the first input terminal IN1 of the j+1th stage. In this case, the carry signal, output from the carry-signal output terminal Cout of the first sub-stage SUB1 of the j-th stage STj, may be input into the second input terminal IN2 of the j−1th stage, the third input terminal IN3 of the j−2th stage, and the first input terminal IN1 of the j+1th stage.

The first sub-stage SUB1 of the j-th stage STj includes a first node charge unit 110, a second node control unit 120, a first carry-signal output unit 130, a first scan-signal output unit 140, a first node discharge unit 150, a second node discharge unit 160, a second carry-signal output unit 170 and a second scan-signal output unit 180.

The first node charge unit 110 charges a first node N1 to gate on voltage. In the embodiment of the present invention, the first node N1 is described as a pull-up control node. To be more specific, the first node charge unit 110 charges the first node N1 to the gate on voltage in response to the start signal input into the first input terminal IN1 or the carry signal of the front stage. In this regard, the carry signal of the front stage may be the signal that is output from the carry-signal output terminal Cout of the j−1th stage.

The first node charge unit 110 may include a first transistor T1. The first transistor T1 is turned on in response to the start signal having the gate on voltage or the carry signal of the front stage, thus allowing the first node N1 to be charged to the gate on voltage. A gate electrode of the first transistor T1 and a second electrode of the first transistor T1 may be connected to the first input terminal IN1, and a first electrode of the first transistor T1 may be connected to the first node N1. In this context, the first electrode may be a source electrode or a drain electrode, while the second electrode may be an electrode different from the first electrode. For example, if the first electrode is the source electrode, the second electrode may be the drain electrode.

The second node control unit 120 charges or discharges the second node N2, in response to the clock signal that is input through the clock terminal CLK. In the embodiment of the present invention, the second node N2 is described as a pull-down control node.

The second node control unit 120 may include second and third transistors T2 and T3. If the clock signal input through the clock terminal CLK is the gate on voltage, the second transistor T2 is turned on, thus allowing a third node N3 to be charged to the gate on voltage. A gate electrode of the second transistor T2 and the second electrode are connected to the clock terminal CLK, while the first electrode is connected to the third node N3.

Further, if the third node N3 is the gate on voltage, the third transistor T3 is turned on, thus controlling the second node N2 to the voltage level of the clock signal that is input through the clock terminal CLK. For example, if the clock signal input through the clock terminal CLK is the gate on voltage when the third transistor T3 is turned on, the gate on voltage is supplied to the third node N3. Meanwhile, if the clock signal input through the clock terminal CLK is the gate off voltage, the gate off voltage may be supplied to the third node N3.

The first carry-signal output unit 130 output the clock signal, which is input through the clock terminal CLK depending on the voltage of the first node N1, to a carry-signal output terminal Cout. The first carry-signal output unit 130 may include a fourth transistor T4.

When the first node N1 is the gate on voltage, the fourth transistor T4 is turned on, so that the clock signal input through the clock terminal CLK is output to the carry-signal output terminal Cout. A gate electrode of the fourth transistor T4 is connected to the first node N1, the first electrode of the fourth transistor T4 is connected to the carry-signal output unit ROUT, and the second electrode of the fourth transistor T4 is connected to the clock terminal CLK.

Since the fourth node N4 is connected to the carry-signal output terminal Cout, the fourth node N4 is charged to the gate on voltage if the first node N1 is the gate on voltage and the clock signal input through the clock terminal CLK is the gate on voltage. Further, if the first node N1 is the gate on voltage and the clock signal input through the clock terminal CLK is the gate off voltage, the fourth node N4 is discharged to the gate off voltage.

The first scan-signal output unit 140 outputs the clock signal, which is input through the clock terminal CLK depending on the voltage of the first node N1, to the j-th scan line Gj. The first scan-signal output unit 140 may include a pull-up transistor TU and a first capacitor C1.

When the first node N1 is the gate on voltage, the pull-up transistor TU is turned on, so that the clock signal input through the clock terminal CLK is output to the j-th scan line Gj. Particularly, the pull-up transistor TU may be implemented to be completely turned on, when the first node N1 is bootstrapped by the first capacitor C1 to rise to a level which is equal to or more than the gate on voltage. The gate electrode of the pull-up transistor TU is connected to the first node N1, the first electrode of the pull-up transistor TU is connected to the j-th scan line Gj, and the second electrode of the pull-up transistor TU is connected to the clock terminal CLK.

The first capacitor C1 is connected between the gate electrode of the pull-up transistor TU and the first electrode of the pull-up transistor TU. The first capacitor C1 serves as a boosting capacitor that applies a variation in voltage of the j-th scan line Gj to the first node N1.

The first node discharge unit 150 discharges the first node N1 to the second low-potential voltage VSS2. To be more specific, the first node discharge unit 150 discharges the first node N1 to the second low-potential voltage in response to the carry signal of the rear stage that is input into the second input terminal IN2. Further, the first node discharge unit 150 discharges the first node N1 to the second low-potential voltage in response to the carry signal of the rear stage that is input into the third input terminal IN3. Further, the first node discharge unit 150 discharges the first node N1 to the second low-potential voltage depending on the voltage of the second node N2.

The first node discharge unit 150 may include fifth, sixth, seventh and eighth transistors T5, T6, T7 and T8. When the carry signal of the rear stage input into the third input terminal IN3 is the gate on voltage, the fifth transistor T5 is turned on, so that the first node N1 is discharged to the second low-potential voltage VSS2. A gate electrode of the fifth transistor T5 is connected to the third input terminal IN3, the first electrode of the fifth transistor T5 is connected to the second voltage input terminal Vin2, and the second electrode of the fifth transistor T5 is connected to the first node N1.

If the second node N2 is the gate on voltage, the sixth transistor T6 is turned on, so that the first node N1 is discharged to the second low-potential voltage VSS2. A gate electrode of the sixth transistor T6 is connected to the second node N2, the first electrode of the sixth transistor T6 is connected to the second voltage input terminal Vin2, and the second electrode of the sixth transistor T6 is connected to the first node N1.

If the carry signal of another rear stage which is input into the second input terminal IN2 is the gate on voltage, seventh and eighth transistors T7 and T8 are turned on, so that the first node N1 is discharged to the second low-potential voltage VSS2. A gate electrode of the seventh transistor T7 is connected to the second input terminal IN2, a first electrode of the seventh transistor T7 is connected to a gate electrode of the eighth transistor T8 and a second electrode of the eighth transistor T8, and the second electrode of the seventh transistor T7 is connected to the first node N1. The gate electrode of the eighth transistor T8 and the second electrode of the eighth transistor T8 are connected to the first electrode of the seventh transistor T7, and the first electrode of the eighth transistor T8 is connected to the second voltage input terminal Vin2.

The second node discharge unit 160 discharges the second node N2. To be more specific, the second node discharge unit 160 discharges the second node N2 to the second low-potential voltage VSS2 in response to the carry signal of the front stage which is input into the first input terminal IN1. Further, the second node discharge unit 160 discharges the second node N2 to the first low-potential voltage VSS1 depending on the voltage of the fourth node N4. Moreover, the second node discharge unit 160 may perform a function of discharging the third node N3 to the first low-potential voltage VSS1.

The second node discharge unit 160 may include ninth to eleventh transistors T9, T10 and T11. If the carry signal of the front stage input into the first input terminal IN1 is the gate on voltage, the ninth transistor T9 is turned on, thus discharging the second node N2 to the second low-potential voltage VSS2. A gate electrode of the ninth transistor T9 is connected to the first input terminal IN1, the first electrode of the ninth transistor T9 is connected to the second voltage input terminal Vin2, and the second electrode of the ninth transistor T9 is connected to the second node N2.

If the fourth node N4 is the gate on voltage, the tenth transistor T10 is turned on, thus discharging the third node N3 to the first low-potential voltage VSS1. A gate electrode of the tenth transistor T10 is connected to the fourth node N4, a first electrode of the tenth transistor T10 is connected to the first voltage input terminal Vin1, and a second electrode of the tenth transistor T10 is connected to the third node N3.

If the fourth node N4 is the gate on voltage, the eleventh transistor T11 is turned on, thus discharging the second node N2 to the first low-potential voltage VSS1. A gate electrode of the eleventh transistor T11 is connected to the fourth node N4, a first electrode of the eleventh transistor T11 is connected to the first voltage input terminal Vin1, and a second electrode of the eleventh transistor T11 is connected to the second node N2.

The second carry-signal output unit 170 discharges the fourth node N4 connected to the carry-signal output terminal Cout to the second low-potential voltage VSS2. Hence, the second low-potential voltage VSS2 is output to the carry-signal output terminal Cout of the j-th stage STj.

The second carry-signal output unit 170 may include twelfth and thirteenth transistors T12 and T13. If the carry signal of the rear stage input through the second input terminal IN2 is the gate on voltage, the twelfth transistor T12 is turned on, thus discharging the fourth node N4 to the second low-potential voltage VSS2. A gate electrode of the twelfth transistor T12 is connected to the second input terminal IN2, a first electrode of the twelfth transistor T12 is connected to the second voltage input terminal Vin2, and a second electrode of the twelfth transistor T12 is connected to the fourth node N4.

If the second node N2 is the gate on voltage, the thirteenth transistor T13 is turned on, thus discharging the fourth node N4 to the second low-potential voltage VSS2. A gate electrode of the thirteenth transistor T13 is connected to the second node N2, a first electrode of the thirteenth transistor T13 is connected to the second voltage input terminal Vin2, and a second electrode of the thirteenth transistor T13 is connected to the fourth node N4.

The second scan-signal output unit 180 discharges the j-th scan line Gj to the first low-potential voltage VSS1 depending on the voltage of the second node N2. The second scan-signal output unit 180 may include a pull-down transistor TD.

If the second node N2 is the gate on voltage, the pull-down transistor TD is turned on, thus discharging the j-th scan line Gj to the first low-potential voltage VSS1. A gate electrode of the pull-down transistor TD is connected to the second node N2, a first electrode of the pull-down transistor TD is connected to the j-th scan line Gj, and a second electrode of the pull-down transistor TD is connected to the first voltage input terminal Vin1.

Hereinbefore, the gate on voltage means the turn-on voltage of the transistors of the first sub-stage SUB1, while the gate off voltage means the turn-off voltage of the transistors of the first sub-stage SUB1. Further, the first and second low-potential voltage VSS1 and VSS2 may be the gate off voltage. Although FIG. 4 show that the transistors of the first sub-stage SUB1 are formed in N-type metal oxide semiconductor field effect transistors (MOSFET), the transistors may be formed in P-type MOSFETs without being limited to the N-type MOSFETs.

It is to be noted that the first sub-stage SUB1 of the j-th stage STj according to the embodiment of the present invention be limited to the embodiment shown in FIG. 4. That is, it is to be understood by those skilled in the art that the first sub-stage SUB1 of the j-th stage STj according to the embodiment of the present invention may be substituted by another one, as long as it is possible to supply the scan signal to the j-th scan line Gj, by controlling the pull-up transistor connected to the pull-up control node and the pull-down transistor connected to the pull-down control node using the signals input from the plurality of input terminals, at least one clock terminal, at least one voltage input terminal and the voltage.

The second sub-stage SUB2 of the j-th stage STj will be described in detail. Referring to FIG. 4, the second sub-stage SUB2 includes a discharge control switch element DCT as an active element. The discharge control switch element DCT discharges the j-th scan line Gj to the low-potential voltage in response to the carry signal of the rear stage input through the second input terminal Vin2. A gate electrode of the discharge control switch element DCT is connected to the second input terminal Vin2, a first electrode of the discharge control switch element DCT is connected to the j-th scan line Gj, and a second electrode of the discharge control switch element DCT is the low-potential voltage terminal VSST.

According to the embodiment of the present invention, the discharge control switch element DCT prevents the falling of the scan signal of the j-th scan line Gj from being delayed. If the discharge control switch element DCT is omitted, the falling of the scan signal of the j-th scan line Gj may be delayed. This causes a problem wherein the pixels connected to the j-th scan line Gj may be negatively affected by data voltage that is to be supplied to the pixels connected to the j+1th scan line Gj+1.

Consequently, since the discharge control switch element DCT plays an important role in stably supplying the scan signal to the j-th scan line Gj, the area of the discharge control switch element DCT in the j-th stage STj is larger than that of another switch element. Thus, according to the embodiment of the present invention, the discharge control switch element DCT that occupies a relatively large area in the j-th stage STj is formed in the first region A1 of the display region DA, thus being capable of reducing the area of the scan driver 10 formed in the non-display region NDA. As a result, the embodiment of the present invention achieves a reduction in the non-display region NDA of the display panel DIS, thus being capable of reducing the bezel region of the display device.

The pixels P1 of the first region A1 connected to the j-th scan line Gj will be described in detail. Referring to FIG. 4, each of the pixels P1 of the first region A1 includes a first switch element ST1, a first pixel electrode PE1, and a first storage capacitor CS1. The first switch element ST1 supplies a data voltage of the k-th (k is the natural number satisfying the following equation, 1≦k≦i) data line Dk to the first pixel electrode PE1 and an electrode provided on a side of the first storage capacitor CS1 in response to the scan signal of the j-th scan line Gj. A gate electrode of the first switch element ST1 is connected to the j-th scan line Gj, a first electrode of the first switch element ST1 is connected to the first pixel electrode PE1 and the electrode provided on a side of the first storage capacitor CS1, and a second electrode of the first switch element ST1 is connected to the k-th data line Dk.

The first pixel P1 drives the liquid crystal of the liquid crystal layer by the electric field between data voltage of the first pixel electrode PE1 and common voltage Vcom of the common electrode CE, thus adjusting the transmission of light and thereby displaying an image. The first storage capacitor CS1 maintains data voltage supplied to the first pixel electrode PE1 for a predetermined period of time.

As shown in FIG. 4, according to the embodiment of the present invention, the active element of the scan driver 10 is formed in the first region A1 of the display region DA, thus reducing the area of the scan driver 10 formed in the non-display region NDA. Thereby, the embodiment of the present invention can reduce the non-display region NDA of the display panel DIS, thus leading to a reduction in the bezel region of the display device.

FIG. 5 is an equivalent circuit diagram showing an example of pixels in a second region connected to the j-th scan line of FIG. 3. In FIG. 5, the pixels P2 of the second region A2 connected to the j-th scan line Gj are shown. As shown in FIG. 5, the pixels P2 of the second region A2 may be pixels that are connected to the i+1th to the m-th data lines Di+1 to Dm. Each of the pixels P2 of the second region A2 includes a plurality of sub-pixels. For example, each of the pixels P2 of the second region A2 may include first and second sub-pixels PSUB1 and PSUB2, as shown in FIG. 5.

Referring to FIG. 5, the first sub-pixel PSUB1 includes a second switch element ST2, a second pixel electrode PE2, and a second storage capacitor CS2. The second switch element ST2 supplies the data voltage of the p-th (p is the natural number satisfying the following equation, i+1≦p≦m) data line Dp to the second pixel electrode PE2 and the electrode provided on one side of the second storage capacitor CS2 in response to the scan signal of the j-th scan line Gj. A gate electrode of the second switch element ST2 is connected to the j-th scan line Gj, a first electrode is connected to the second pixel electrode PE2 and the electrode provided on one side of the second storage capacitor CS2, and a second electrode is connected to the p-th data line Dp.

The first sub-pixel PSUB1 drives the liquid crystal of the liquid crystal layer by the electric field between data voltage of the second pixel electrode PE2 and common voltage Vcom of the common electrode CE, thus adjusting the transmission of light and thereby displaying an image. The second storage capacitor CS2 maintains data voltage supplied to the second pixel electrode PE2 for a predetermined period of time.

The second sub-pixel PSUB2 includes third and fourth switch elements ST3 and ST4, a third pixel electrode PE3, and a third storage capacitor CS3. The third switch element ST3 supplies the data voltage of the p-th data line Dp to the third pixel electrode PE3 and the electrode provided on one side of the third storage capacitor CS3 in response to the scan signal of the j-th scan line Gj. A gate electrode of the third switch element ST3 is connected to the j-th scan line Gj, a first electrode is connected to the third pixel electrode PE3 and the electrode provided on one side of the third storage capacitor CS3, and the second electrode is connected to the p-th data line Dp.

The fourth switch element ST4 supplies reference voltage Vref of a reference voltage line to the third pixel electrode PE3 and the electrode provided on one side of the third storage capacitor CS3 in response to the scan signal of the j-th scan line Gj. A gate electrode of the fourth switch element ST4 is connected to the j-th scan line Gj, the first electrode is connected to the reference voltage line, and the second electrode is connected to the third pixel electrode PE3 and the electrode provided on one side of the third storage capacitor CS3. The reference voltage Vref may be equal to or lower than peak black grayscale voltage. The peak black grayscale voltage means the voltage that renders the pixel supplied with the voltage to display a peak black grayscale when the voltage is supplied to the pixel electrode.

The third and fourth switch elements ST3 and ST4 are simultaneously turned on, so that the third pixel electrode PE3 and the electrode provided on one side of the third storage capacitor CS3 are charged to voltage having a level between the data voltage and the reference voltage. The third sub-pixel PSUB3 drives the liquid crystal of the liquid crystal layer by the electric field between the voltage having the level between the data voltage of the third pixel electrode PE3 and the reference voltage, and the common voltage Vcom of the common electrode CE, thus adjusting the transmission of light and thereby displaying the image. The third storage capacitor CS3 maintains data voltage supplied to the third pixel electrode PE3 for a predetermined period of time.

Consequently, the first sub-pixel PSUB1 displays a grayscale that is to be displayed by the data voltage supplied through the p-th data line Dp, while the second sub-pixel PSUB2 displays a grayscale lower than the grayscale that is to be displayed by the data voltage supplied through the p-th data line Dp. That is, according to the embodiment of the present invention, the third pixel electrode PE3 of the second sub-pixel PSUB2 is charged to the voltage of the grayscale lower than the grayscale that is to be displayed. Therefore, according to the embodiment of the present invention, when the display panel DIS is driven in the vertical field driving method such as the VA mode, an inclined angle of the liquid crystal of the liquid crystal layer is gently adjusted, thus improving side visibility.

Further, according to the embodiment of the present invention, the pixels P2 of the second region A2 are formed to include a plurality of pixel electrodes as shown in FIG. 5, whereas the pixels P1 of the first region A1 are formed to include one pixel electrode as shown in FIG. 4. The reason is as follows: since the active element of the scan driver 10 as well as the pixels P1 is formed in the first region A1 and thereby an area for forming each pixel P1 in the first region A1 is decreased, luminance may be excessively lowered if each pixel P1 of the first region A1 includes the plurality of pixel electrodes in the same manner as the second region A2. Therefore, the embodiment of the present invention can minimize a difference between the luminance of the pixel of the first region A1 and the luminance of the pixel of the second region A2.

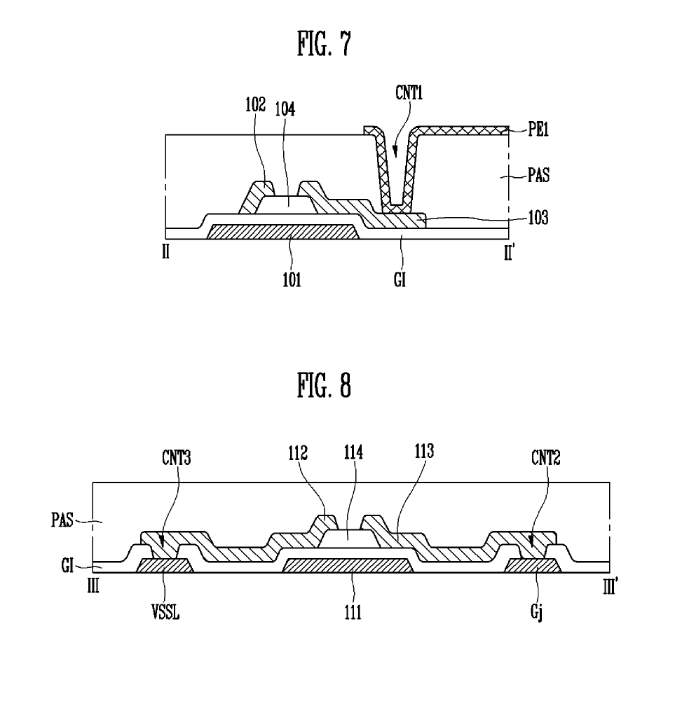

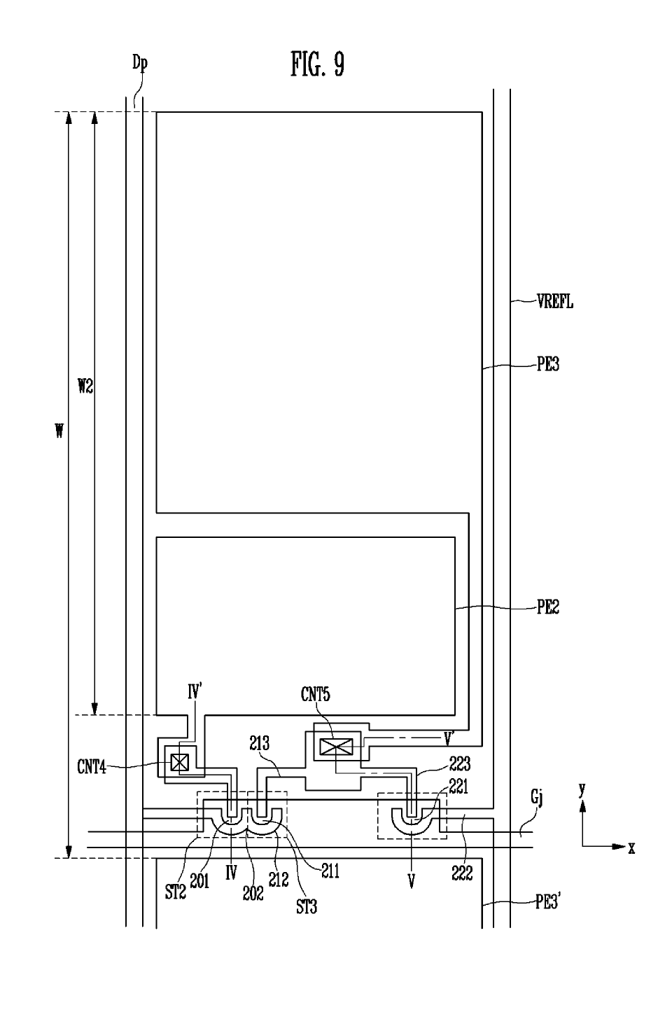

FIG. 6 is a plan view showing an example of the pixels in the first region of FIG. 4. FIG. 7 is a sectional view taken along the line II-II′ of FIG. 6. FIG. 8 is a sectional view taken along the line III-III′ of FIG. 6.

Referring to FIG. 6, the active element of the scan driver 10 is formed between the pixels P1 of the first region A1. FIG. 6 shows the pixel P1 of the first region A1 and the discharge control switch element DCT of the scan driver 10 formed next to the pixel P1.

Referring to FIGS. 6 to 8, the pixel P1 of the first region A1 includes the first switch element ST1 and the first pixel electrode PE1. For the convenience of description, FIGS. 6 to 8 do not show the first storage capacitor CS1.

The gate electrode 101 of the first switch element ST1 extends from the j-th scan line Gj, the first electrode 102 of the first switch element ST1 extends from the k-th data line Dk, and the second electrode 103 of the first switch element ST1 is formed to be spaced apart from the first electrode 102 by a predetermined distance, and is connected to the first pixel electrode PE1 via a first contact hole CNT1.

The gate electrode 111 of the discharge control switch element DCT of the scan driver 10 extends from the j+1th carry-signal line RLj+1, the first electrode 112 of the discharge control switch element DCT is connected to the j-th scan line Gj via a second contact hole CNT2, and the second electrode 113 of the discharge control switch element DCT is formed to be spaced apart from the first electrode 112 by a predetermined distance, and is connected to the low-potential voltage line VSSL via a third contact hole CNT3. Since the j+1th carry-signal line RLj+1 is the line connected to the carry-signal output unit Cout of the j+1th stage, this line transmits the carry signal of the j+1th stage.

The j-th scan line Gj, the j+1th carry-signal line RLj+1, the low-potential voltage line VSSL, the gate electrode 101 of the first switch element ST1, and the gate electrode 111 of the discharge control switch element DCT are formed in a gate metal pattern. The gate insulation layer GI is formed on the gate metal pattern to protect and insulate the gate metal pattern. But, the second contact hole CNT2 is formed in the gate insulation layer GI to connect the first electrode 112 of the discharge control switch element DCT to the j-th scan line Gj, and the third contact hole CNT3 is formed in the gate insulation layer GI to connect the second electrode 113 of the discharge control switch element DCT to the low-potential voltage line VSSL. The k-th data line Dk, the first and second electrodes 102 and 103 of the first switch element ST1, and the first and second electrodes 112 and 113 of the discharge control switch element DCT are formed on the gate insulation layer GI in the data metal pattern. A passivation layer PAS is formed on the data metal pattern to protect and insulate the data metal pattern. But, the first contact hole CNT1 is formed in the passivation layer PAS to connect the second electrode 103 of the first switch element ST1 to the first pixel electrode PE1. The first pixel electrode PE1 is formed on the passivation layer PAS.

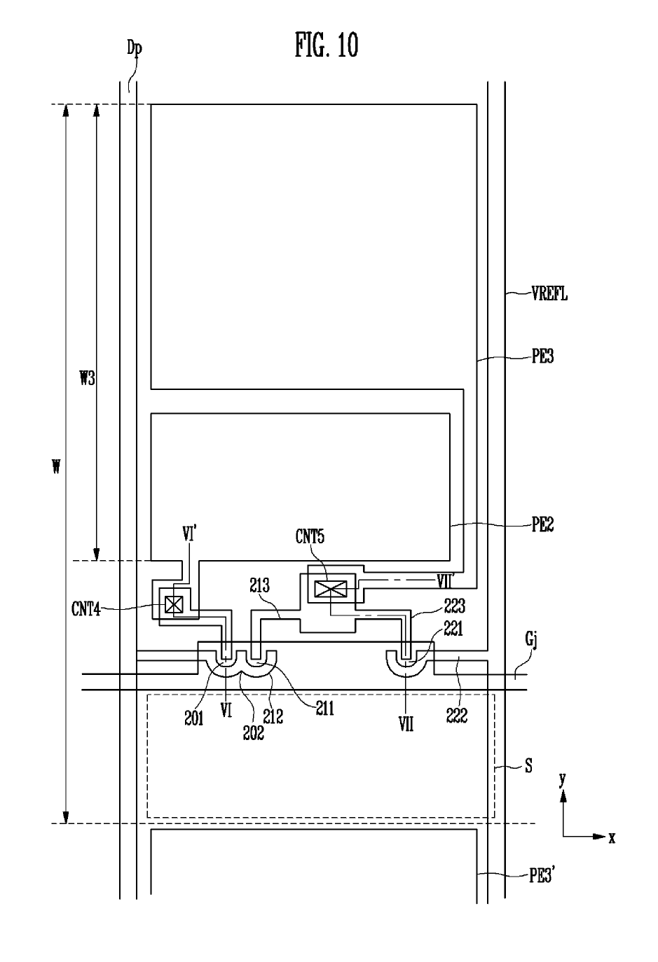

FIG. 9 is a plan view showing an example of the pixels in the second region of FIG. 5. Since the sectional views of FIG. 9 taken along the line IV-IV′ and line V-V′ are similar to the sectional view of FIG. 7 taken along the line II-II′, the sectional views are omitted herein.

Referring to FIG. 9, the pixel P2 of the second region A2 includes a plurality of sub-pixels. FIG. 9 shows that the pixel P2 of the second region A2 includes first and second sub-pixels PSUB1 and PSUB2.

Referring to FIG. 9, the first sub-pixel PSUB1 of the second region A2 includes the second switch element ST2 and the second pixel electrode PE2, and the second sub-pixel PSUB2 includes the third switch element ST3, the fourth switch element ST4, and the third pixel electrode PE3. For the convenience of description, the second and third storage capacitors CS2 and CS3 are not shown in FIG. 9.

Although the second pixel electrode PE2 may be formed to have an area smaller than that of the third pixel electrode PE3, it is to be noted that this invention is not limited thereto. The second pixel electrode PE2 may be formed such that its area is equal to or larger than that of the third pixel electrode PE3, and the areas of the second and third pixel electrodes PE2 and PE3 may be previously determined through experiments in consideration of the side visibility and luminance.

The gate electrode 201 of the second switch element ST2 extends from the j-th scan line Gj, the first electrode 202 of the second switch element ST2 extends from the p-th data line Dp, and the second electrode 203 of the second switch element ST2 is formed to be spaced apart from the first electrode 202 by a predetermined distance and is connected to the second pixel electrode PE2 via a fourth contact hole CNT4.

The gate electrode 211 of the third switch element ST3 extends from the j-th scan line Gj, the first electrode 212 of the third switch element ST3 extends from the p-th data line Dp, and the second electrode 213 of the third switch element ST3 is formed to be spaced apart from the first electrode 212 by a predetermined distance, is connected to the second electrode 223 of the fourth switch element ST4, and is connected to the third pixel electrode PE3 via a fifth contact hole CNT5.

The gate electrode 221 of the fourth switch element ST4 extends from the j-th scan line Gj, the first electrode 222 of the fourth switch element ST4 extends from the reference voltage line VREFL, and the second electrode 223 of the fourth switch element ST4 is formed to be spaced apart from the first electrode 222 by a predetermined distance, is connected to the second electrode 213 of the third switch element ST3, and is connected to the third pixel electrode PE3 via a fifth contact hole CNT5.

The j-th scan line Gj, the gate electrode 201 of the second switch element ST2, the gate electrode 211 of the third switch element ST3, and the gate electrode 221 of the fourth switch element ST4 are formed in a gate metal pattern. The gate insulation layer is formed on the gate metal pattern to protect and insulate the gate metal pattern. The p-th data line Dp, the first and second electrodes 202 and 203 of the second switch element ST2, the first and second electrodes 212 and 213 of the third switch element ST3, and the first and second electrodes 222 and 223 of the fourth switch element ST4 are formed on the gate insulation layer GI in the data metal pattern. A passivation layer is formed on the data metal pattern to protect and insulate the data metal pattern. But, the fourth contact hole CNT4 is formed in the passivation layer to connect the second electrode 203 of the second switch element ST2 to the second pixel electrode PE2, and the fifth contact hole CNT5 is formed in the passivation layer to connect the second electrodes 213 and 223 of the third and fourth switch elements ST3 and ST4 to the third pixel electrode PE3. The second and third pixel electrodes PE2 and PE3 are formed on the passivation layer.

Meanwhile, as shown in FIGS. 6 and 9, the Y-axis width of the region where the pixel P1 of the first region A1 and the discharge control switch element DCT are formed, and the Y-axis width of the region where the pixel P2 of the second region A2 is formed, may be denoted by “W”. In this case, the Y-axis width of the first pixel electrode PE1 of the pixel P1 of the first region A1 may be “W1” that is smaller than the width W due to the discharge control switch element DCT, and the Y-axis width of the region where the second and third pixel electrodes PE2 and PE3 of the pixel P2 of the second region A2 are formed may be “W2”. That is, the area of the first pixel electrode PE1 of the pixel P1 of the first region A1 is smaller than the combined areas of the second and third pixel electrodes PE2 and PE3 of the pixel P2 of the second region A2. Alternatively, the width W1 of the pixel P1 may be smaller than the width W2 of the pixel. Thus, if the pixel P1 of the first region A1 includes the plurality of pixel electrodes, the luminance of the pixel P1 of the first region A1 may be significantly reduced as compared to the luminance of the pixel P2 of the second region A2. Hence, this causes a user to feel a difference of luminance between the first and second regions A1 and A2. Therefore, according to the embodiment of the present invention, the pixel P1 of the first region A1 is implemented to include only the first pixel electrode PE1, in order to minimize a reduction in luminance of the pixel P1 of the first region A1, which results from the formation of the active element of the scan driver 10 in the first region A1.

FIG. 10 is a plan view showing another example of the pixels in the second region of FIG. 5. Since the sectional views of FIG. 10 taken along line IV-IV′ and line V-V′ are similar to the sectional view of FIG. 7 taken along line II-II′, the sectional views are omitted herein. Since the pixel P2 of the second region A2 shown in FIG. 10 is formed to be substantially equal to the pixel P2 of the second region A2 shown in FIG. 9, a detailed description thereof will be omitted.

Although the pixel P1 of the first region A1 includes one pixel electrode, there may occur in a difference of luminance between the pixel P1 of the first region A1 and the pixel P2 of the second region A2. That is, the luminance of the pixel P2 of the second region A2 may be higher than the luminance of the pixel P1 of the first region A1. In order to minimize the difference of luminance between the pixel P1 of the first region A1 and the pixel P2 of the second region A2, according to the embodiment of the present invention, the Y-axis width of the region where the second and third pixel electrodes PE2 and PE3 of the pixel P2 of the second region A2 are formed may be “W3” that is smaller than “W2”, as shown in FIG. 10. Particularly, “W3” may be the width that is determined through experiments, so as to minimize the difference of luminance between the pixel P1 of the first region A1 and the pixel P2 of the second region A2. In this case, the embodiment of the present invention may include a predetermined space S that is defined between the pixels P2 of the second region A2 and is shielded by the shield member, as shown in FIG. 10. The predetermined space S corresponds to a space where any wiring line and any metal pattern for forming the active element are not formed, as shown in FIG. 10. Consequently, the embodiment of the present invention adjusts the width of the region where the second and third pixel electrodes PE2 and PE3 of the pixel P2 of the second region A2 are formed, thus minimizing the difference of luminance between the pixel P1 of the first region A1 and the pixel P2 of the second region A2.

By way of summation and review, according to the embodiment of the present invention, a portion of the scan driver is formed in the first region of the display region, thus allowing an area of the scan driver formed in the non-display region to be reduced. Consequently, the embodiment of the present invention can reduce the non-display region of the display panel, thus allowing the bezel region of the display device to be reduced.

Further, according to the embodiment of the present invention, each of the pixels of the second region is formed to include the plurality of pixel electrodes, any one of the pixel electrodes is charged to the data voltage, and another pixel electrode is charged to the voltage of grayscale lower than that which is to be displayed in the data voltage. As a result, the embodiment of the present invention can gently adjust the inclined angle of the liquid crystal of the liquid crystal layer in the vertical field driving method such as the VA mode, thus improving side visibility.

Furthermore, according to the embodiment of the present invention, each of the pixels of the first region is formed to include one pixel electrode. Therefore, the embodiment of the present invention can minimize the difference of luminance between the pixel of the first region and the pixel of the second region. Particularly, the embodiment of the present invention adjusts the width of the region where the plurality of pixel electrodes of the pixel of the second region are formed, thus further reducing the difference of luminance between the pixel of the first region and the pixel of the second region.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A display device, comprising:
a display panel divided into a display region and a non-display region, the display region having data lines, scan lines, and pixels connected to the data lines and the scan lines, the display region including a first region and a second region;
a data driver to output data voltage to the data lines; and
a scan driver to sequentially output scan signals to the scan lines, a first portion of the scan driver formed in the non-display region, a second portion of the scan driver formed in the first region, a pixel of the pixels formed in the first region including a single pixel electrode, a pixel of the pixels formed in the second region including a plurality of pixel electrodes.

2. The display device as claimed in claim 1, wherein the scan driver comprises
a plurality of stages that are connected by a cascade joint to sequentially output the scan signals, each stage of the stages comprising a first sub-stage formed in the non-display region, and a second sub-stage formed between pixels of the first region.

3. The display device as claimed in claim 2, wherein the second sub-stage comprises at least one active element.

4. The display device as claimed in claim 3, wherein the first sub-stage comprises:
a pull-up switch element to output a clock signal, which is input into a clock terminal, into a scan line in response to a voltage of a pull-up control node;
a pull-down switch element to discharge the scan line to a gate off voltage in response to a voltage of a pull-down control node; and
a node control circuit to control the voltage of the pull-up control node and the voltage of the pull-down control node.

5. The display device as claimed in claim 3, wherein the second sub-stage comprises:
a discharge control switch element to apply a gate off voltage to a scan line in response to a carry signal of a rear stage.

6. The display device as claimed in claim 1, wherein the pixel of the first region connected to a j-th (j is a natural number) scan line comprises:
a first pixel electrode; and
a first switch element to supply a data voltage of a k-th (k is a natural number) data line to the first pixel electrode in response to a scan signal of the j-th scan line.

7. The display device as claimed in claim 6, wherein the pixel of the second region connected to the j-th scan line comprises a first sub-pixel and a second sub-pixel.

8. The display device as claimed in claim 7, wherein the first sub-pixel comprises:
a second pixel electrode; and
a second switch element to supply a data voltage of a p-th (p is a natural number different from the k) data line to the second pixel electrode in response to the scan signal of the j-th scan line.

9. The display device as claimed in claim 7, wherein the second sub-pixel comprises:
a third pixel electrode;
a third switch element to supply the data voltage of the p-th (p is a natural number different from the k) data line to the third pixel electrode in response to the scan signal of the j-th scan line; and
a fourth switch element to supply a reference voltage of a reference voltage line to the third pixel electrode in response to the scan signal of the j-th scan line.

10. The display device as claimed in claim 1, wherein a predetermined space is formed between the pixels of the second region and is covered by a shield member.

11. The display device as claimed in claim 10, wherein the predetermined space is a space where none of wiring lines and metal patterns for forming an active element is formed.

12. The display device as claimed in claim 2, wherein the first portion of the scan driver includes the first sub-stage and the second portion of the scan driver includes the second sub-stage.

13. The display device as claimed in claim 1, wherein an area of the single pixel electrode of the pixel formed in the first region is smaller than combined areas of the plurality of the pixel electrodes of the pixel formed in the second region.

14. The display device as claimed in claim 1, wherein the plurality of pixel electrodes of the pixel of the pixels formed in the second region are all connected to the same scan line of the scan lines.

15. The display device as claimed in claim 1, wherein the single pixel electrode of the pixel of the pixels formed in the first region and the plurality of pixel electrodes of the pixel of the pixels formed in the second region are all connected to the same scan line of the scan lines.

16. The display device as claimed in claim 6, wherein the k-th date line is disposed in the first region.

17. The display device as claimed in claim 8, wherein the p-th date line is disposed in the second region.

18. The display device as claimed in claim 9, wherein the p-th date line is disposed in the second region.
